(19) United States
(12) Patent Application Publication
(10) Pub. No.: US 2025/0334048 A1
(43) Pub. Date: Oct. 30, 2025

(54) MONITORING DOWNHOLE COMPONENTS OF COMPLETION ASSEMBLY USING DISTRIBUTED ACOUSTIC SENSING

(71) Applicant: Weatherford Technology Holdings, LLC, Houston, TX (US)

(72) Inventors: Steven W. Mathias, Houston, TX (US); Virgilio Porto, Houston, TX (US); Colin Jordan, Aberdeen (GB)

(21) Appl. No.: 18/647,218

(22) Filed: Apr. 26, 2024

Related U.S. Application Data
(60) Provisional application No. 63/638,295, filed on Apr. 24, 2024.

(51) Int. Cl. E21B 47/135; E21B 47/008; E21B 47/09

(52) U.S. Cl. CPC E21B 47/135; G01H 9/004

(57) ABSTRACT

A system monitors a completion, which has components disposed at depths in a wellbore. Operational events associated with the components are stored in memory. The system interrogates an optical fiber disposed along the assembly in acoustic communication with the components by injecting input optical signals into the fiber using an optical source. An optical detector detects return optical signals backscattered along the fiber, and a processing unit processes the return optical signals according to a plurality of spatial resolutions for the components along the fiber. Signatures for each of the components are determined at the spatial resolutions along the fiber, and baselines of the signatures over a time span are generated for each of the components. A deviation from the baseline is detected for one of the components, and the detected deviation is correlated to an associated one of the operational events for the component.

### CROSS-REFERENCE TO RELATED APPLICATIONS

This application claims the benefit of U.S. Provisional Appl. No. 63/638,295 filed Apr. 24, 2024, which is incorporated herein by reference.

### BACKGROUND OF THE DISCLOSURE

Current completion practices offer minimal opportunities to monitor the health of downhole components of the completion assembly. Erosion, corrosion, and material build-up (e.g., scale, asphaltenes, debris, etc.) generally go undetected until a well intervention is carried-out, or until a downhole component fails to function correctly. If the deterioration of the health of a completion component could be detected early, then preventative actions could be taken to minimize or eliminate the risks of costly workovers.

The traditional approach to investigate the health of the completion is to run wireline logs, caliper logs, slickline gauge cutters, etc. Also, coiled tubing jetting can be used to remove excess build-up of scale, asphaltenes, debris, and other materials. However, any problems often go undetected until a completion component fails, which can then result in an expensive workover, or a reduction in the well's production potential.

The subject matter of the present disclosure is directed to overcoming, or at least reducing the effects of, one or more of the problems set forth above.

### SUMMARY OF THE DISCLOSURE

In one implementation, a method disclosed herein is implemented using a computerized monitoring system to monitor a completion assembly disposed in a wellbore. The completion assembly has a plurality of downhole components disposed at depths in the wellbore. The method comprises: storing, in memory of the computerized monitoring system, a plurality of operational events associated with the downhole components; and interrogating an optical fiber disposed along the completion assembly and disposed at least in acoustic communication with the downhole components. The interrogation is performed by: injecting, using an optical source of the computerized monitoring system, input signals into the optical fiber; detecting, using an optical detector of the computerized monitoring system, return signals backscattered along the optical fiber; processing, using one or more processors of the computerized monitoring system, the return signals into processed signals according to a plurality of spatial resolutions for the downhole components along the optical fiber; determining, using the one or more processors based on the processed signals, signatures for the downhole components at the spatial resolutions along the optical fiber; and generating, using the one or more processors, baselines of the signatures over a time span for the downhole components. The method also comprises: detecting, using the processing unit, a deviation from the baseline in the signature for at least one of the downhole components; and correlating, using the processing unit, the detected deviation to an associated one of the operational events for the at least one downhole component.

The method can comprise deploying the optical fiber as part of production tubing, as part of casing, or as a separate line for the completion assembly. The operational events can be selected from the group consisting of a leak, a torque buildup, a pressure buildup, a scale buildup, and a flow obstruction.

To interrogate the optical fiber to generate the baselines of the signatures over the time span for each of the downhole components, the interrogation can be performed at least during operational use of the completion assembly over the time span for production from the wellbore.

The method further can comprise: initially interrogating the optical fiber over an initial time span after installation of the completion assembly and before the operational use to generate initial ones of the baselines of the signatures; and/or initially interrogating a calibration optical fiber over a calibration time span for one or more of the downhole components before installation of the completion assembly to generate calibration ones of the baselines of the signatures.

To inject the input signals into the optical fiber, coherent laser pulses can be transmitted along the optical fiber. Coherent Rayleigh Optical Time Domain Reflectometry (COTDR) can be used to detect the return signals backscattered along the optical fiber and to process the return signals according to the plurality of spatial resolutions for the downhole components along the optical fiber.

The processed signals can be associated to disturbances in the optical fiber caused by acoustic waves associated with the downhole components at the spatial resolutions along the optical fiber to process the return signals into the processed signals and to determine the signatures based on the processed signals. The baselines of the signatures over the time span for each of the downhole components can be generated from the disturbances. To detect the deviation from the baseline, a change of the disturbance can be detected with respect to a threshold, which can correspond to the associated one of the operational events for the at least one downhole component. To detect the deviation from the baseline, the disturbance can be detected with respect to an instantiation in the signature, where the instantiation corresponds to the associated one of the operational events for the at least one downhole component.

The method can further comprise performing a preventative action based on the correlation of the detected deviation to the associated one of the operational events for the at least one downhole component. For example, the preventative action can be selected from the group consisting of: performing a chemical injection in the completion assembly, changing an existing chemical injection in the completion assembly, increasing/decreasing a chemical injection rate in the completion assembly, and increasing/decreasing a frequency of exercising the at least one downhole component.

The method can further comprise identifying, using the processing unit, a failure of the at least one downhole component based on the correlation of the detected deviation to the associated one of the operational events for the at least one downhole component.

In another implementation, a programmable storage device is disclosed herein and has program instructions stored thereon for causing one or more processors to perform a method as described above.

In yet another implementation, a system disclosed herein is used for a completion assembly disposed in a wellbore. The completion assembly has a plurality of downhole components disposed at depths in the wellbore. The system comprises a memory, an optical fiber, an interrogator, and one or more processors. The memory stores a plurality of operational events associated with the downhole components, and the optical fiber is disposed along the completion assembly and is disposed at least in acoustic communication with one or more of the downhole components. The interrogator is in optical communication with the optical fiber. The interrogator has an optical generator and an optical detector. The optical generator is configured to inject input signals into the optical fiber, and the optical detector is configured to detect return signals backscattered along the optical fiber. The one or more processors are in operational communication with the interrogator. The one or more processors are configured to: process the return signals into processed signals according to a plurality of spatial resolutions for the downhole components along the optical fiber; determine, from the processed signals, signatures for the downhole components at the spatial resolutions along the optical fiber; generate baselines of the signatures over a time span for the downhole components; detect a deviation from the baseline in the signature for at least one of the downhole components; and correlate the detected deviation to an associated one of the operational events for the at least one downhole component.

In another implementation, a completion assembly is disclosed herein for use in a wellbore. The completion assembly comprises a plurality components for use downhole on the completion assembly in the wellbore and comprises a monitoring system, such as described above.

The foregoing summary is not intended to summarize each potential embodiment or every aspect of the present disclosure.

### BRIEF DESCRIPTION OF DRAWINGS

FIG. 1 illustrates a distributed acoustic sensors (DAS) system for a completion assembly disposed in a wellbore.

FIG. 2 illustrates a schematic view of the completion assembly and the DAS system of the present disclosure.

FIG. 3 illustrates a schematic view of processing components of the DAS system.

FIG. 4 illustrates a process of monitoring downhole components of a completion assembly using distributed acoustic sensing.

FIG. 5 illustrates another schematic view of the completion assembly and the DAS system.

FIG. 6A illustrates a schematic graph showing an example baseline determined by processing according to the present disclosure.

FIG. 6B illustrates a schematic graph showing an example signature deviated with one form of deviation from the baseline.

FIG. 6C illustrates a schematic graph showing another example of a signature deviated with another form of deviation from the baseline.

FIG. 6D illustrates a schematic graph showing yet another of a signature deviated with yet another form of deviation the baseline.

### DETAILED DESCRIPTION

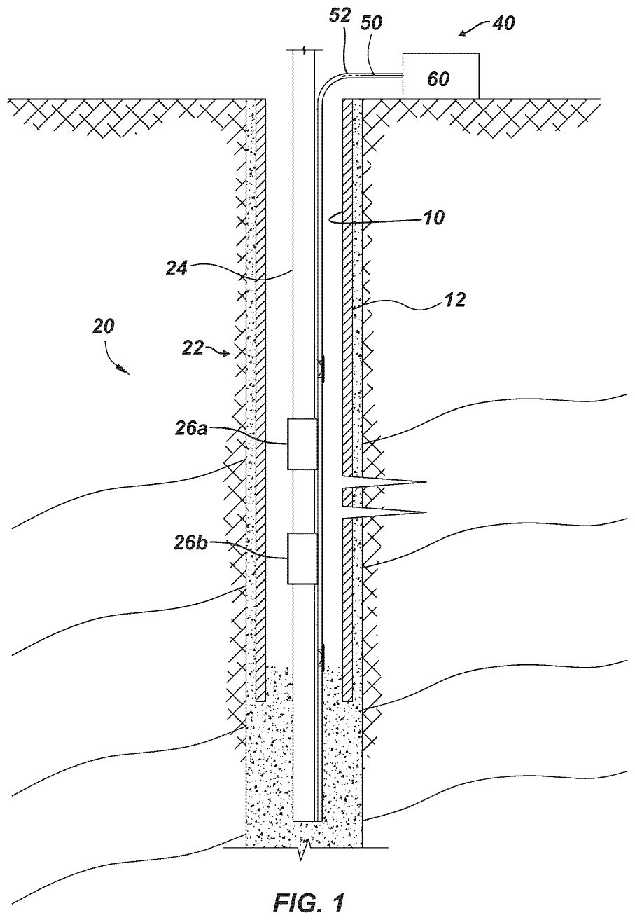

FIG. 1 illustrates a distributed acoustic sensors (DAS) system 40 for a completion assembly 20 disposed in a wellbore 10. The completion assembly 20 includes downhole components 22, including production tubing 24 disposed in the wellbore 10 and including downhole tools 26a-b disposed on the production tubing 24. The wellbore 10 can be cased at least partially with casing 12 or the like.

The DAS system 40 includes an optical waveguide or optical fiber 50 and a monitoring device or interrogator 60. The DAS system 40 may employ a single optical fiber 50 or multiple optical fibers 50 in the same wellbore 10. For example, multiple optical fibers 50 may be utilized in different sections of the wellbore 10 so that sensing may be performed in the different sections. To achieve a comparable result as when using a plurality of optical fibers 50, a single optical fiber 50 can be used along with time division multiplexing or other processes to measure different sensing components on the same optical fiber 50.

The optical fiber 50 can be disposed in an optical cable 52. In turn, the cable 52 having the optical fiber 50 can be suspended in the production tubing 24, disposed in an annulus between the production tubing 24 and the wellbore casing 12, coupled to the outside of the production tubing 24 (as shown), or arranged in another configuration. For the downhole completion assembly 20, the optical fiber 50 can be integrated into the wellbore 10 during the completion process.

Various types of optical fiber 50 can be used for the downhole completion assembly 20. For example, the completion assembly 20 can use one or more of a single-mode optical fiber, a multimode optical fiber, and an engineered optical fiber for the disclosed optical fiber 50.

As a single-mode optical fiber, for example, the disclosed optical fiber 50 can be configured to carry optical signals for the DAS system 40 directly down the optical fiber 50 without much reflection. This can allow the optical signals to travel over longer distances without degradation. Conventionally, the single-mode optical fiber has a small core size (e.g., about 8 to 10 micrometers in diameter), which can limit the optical fiber 50 to providing a single light path or mode, reducing interference, and allowing the light to travel straighter and further. Accordingly, the disclosed optical fiber 50 can use a single-mode fiber when the implementation involves longer distance (greater wellbore depth) so attenuation (loss of signal strength) can be reduced, and dispersion can be minimized.

As a multimode optical fiber, for example, the disclosed optical fiber 50 can have a larger core diameter (e.g., about 50 to 62.5 micrometers in diameter), which allows multiple modes of the optical signals for the DAS system 40 to propagate through the optical fiber 50. Because the larger core size can cause more signal degradation over long distances due to modal dispersion as different modes of the optical signals travel at different speeds and arrive at separate times, the disclosed optical fiber 50 can use a multimode fiber when the implementation involves shorter distances (less wellbore depth).

As an engineered optical fiber (aka a specialty fiber), the disclosed optical fiber 50 can be configured to meet specific requirements for the completion assembly 20 that cannot be provided by single-mode fibers and multimode fibers. For example, the disclosed optical fiber 50 can be configured to have one more modifications to its core material, core geometry, dopant, or the like, to alter the properties of the optical fiber 50 to meet the needs of an implementation. Examples can include a photonic crystal fiber (having a periodic structure in its core material to control light propagation) or a dispersion-compensating fibers (used to counteract the dispersion effects in other types of fibers).

In many implementations, the disclosed optical fiber 50 may use a single-mode optical fiber. In other implementations, the disclosed optical fiber 50 may use a multimode optical fiber to provide additional validation of measurements and/or simultaneous measurements that are combined. Moreover, the disclosed optical fiber 50 may use an engineered optical fiber for implementations in which a limited number of optical fibers are used downhole.

The optical fiber 50 can be deployed as part of the production tubing 24, casing 12, or as a separate fiber line. In one example, the fiber optic cable 52 can be attached to the outside of production tubing 24 by one or more cross-coupling protectors. The fiber optic cable 52 can also be temporarily deployed using coiled tubing, wireline, slickline, or the like.

The optical fiber 50 is coupled to and extends along the completion assembly 20. Should a more extensive monitoring of the acoustic environment be desired, an optical fiber (not shown) can be installed in the cement between the casing 12 and the wellbore 10. In general, the optical fiber 50 can be installed within or on the casing 12, the production tubing 24, or other tubular of the completion assembly 20. Primarily, the optical fiber 50 is acoustically coupled to the downhole components, such as the tubing 24, downhole tools 26, etc. of the completion assembly 20. Different forms of shrouds, armatures, control lines, and channels known in the art can be used to place and protect the optical fiber 50.

The DAS system 40 performs measurements and monitoring related to the components of the completion assembly 20. For example, the completion assembly 20 can include one or more downhole tools 26 disposed on the tubing 24. Depending on the installation, the one or more downhole tools 26 can be any one of several types of tools, such as a subsurface safety valve (e.g., a tubing-retrievable safety valve), a packer, a sliding sleeve, an inflow control valve, a chemical injection device, a gas lift device, an electric submersible pump (ESP), and the like.

By its intrinsic nature, the optical fiber 50 can serve as a distributed sensor through its scattering characteristics. For example, Rayleigh scattering can be used to monitor optical power along the fiber path, Raman scattering can be used to measure the temperature profile along the fiber, and Brillouin scattering can be used to measure the fiber strain profile. In addition, local optical properties of the waveguide 50 can be modified to reflect signals dependent on local physical parameters. For example, fiber Bragg gratings (FBGs) can be used to reflect optical signals centered at varying wavelengths according to the local fiber temperature and strain.

In one aspect, one or more lengths of the optical fiber 50 intended for acoustic sensing may have multiple Bragg gratings (e.g., fiber Bragg gratings (FBGs)) disposed therein. The Bragg gratings may be written directly or spliced into the optical waveguide 50, for example. The DAS system 40 may perform acoustic sensing along the optical waveguide 50 at various sensing regions between the locations of the Bragg gratings.

For example, the monitoring unit 60 can include an optical source, an optical detector, and processing equipment. The optical detector includes an optical-to-electrical converter (e.g., a photodiode) to convert the optical signals reflected from the Bragg gratings to electrical signals, and a processing unit performs signal processing and analysis on the converted reflected signals. In this manner, the DAS system 40 can be used to interferometrically measure any change in length, due to acoustic pressure, of a section of the optical waveguide 50 between Bragg gratings.

The monitoring unit 60 introduces light into the optical fiber 50. The light can be an optical pulse generated using a pulsed laser, for example, in the monitoring device 60. The light introduced by the monitoring unit 60 can then interrogate the Bragg gratings in the optical fiber 50. The interrogation may be based on measurement of interference of two optical pulses at least partially reflected from the Bragg gratings. The interferometric approaches may include any suitable interrogation technique (e.g., using Mach Zehnder, Michaelson, Fabry Perot, ring resonators, polarimetric, and two-mode fiber interferometers).

In another aspect, Rayleigh backscattering may be used along the optical fiber 50, such that the optical fiber 50 may be used for distributed acoustic sensing (DAS), measuring disturbances in scattered light that may be propagated within the waveguide 50. The disturbances in the scattered light may be due to the transmitted, reflected, and/or refracted acoustic energy. The acoustic energy incident on the optical fiber 50 can change the index of refraction of the optical fiber 50, or the acoustic energy can mechanically deform the optical fiber 50 such that the optical propagation time or distance, respectively, changes. Moreover, if the generated acoustic energy is measured at or near the acoustic source (or at some given point), as well as some distance away from the source, then the absorbed energy may also be understood and provide useful information.

One of the parameters that can be measured on the optical fiber 50 is its axial strain. The impact of acoustic energy on the optical fiber 50 creates small axial strains, and these strains can be monitored by measuring the dynamic variation in time of the phase of a coherent optical signal coming from the same location along the optical fiber 50. Small variations in optical path length, or axial strain, may result in a proportional shift in the phase of the received signal.

The DAS system 40 uses coherent Rayleigh scattering back reflections. The DAS system 40 sends a coherent, pulse of laser light down the optical fiber 50, measuring sequentially the phase of Rayleigh backscattering at high frequency, and associating consecutive fiber segments to each signal. By monitoring the phase variations for each fiber segment, the optical fiber 50 is effectively divided into consecutive acoustic sensors. With this approach, the optical fiber 50 becomes a distributed acoustic sensor.

During operations, acoustic sources in the wellbore (10), in the surrounding formation, and elsewhere may generate and emit acoustic energy downhole. The acoustic energy may interact with components (e.g., tubing 24, downhole tools 26, etc.) of the completion assembly (10), leading to transmitted, reflected, refracted, and/or absorbed acoustic energy. Additionally, components (e.g., tubing 24, downhole tools 26, etc.) of the completion assembly 10 may themselves generate and emit acoustic energy when the components experience changes, operate over time, and the like. The acoustic energy may be generated actively, such as when a downhole tool 20 is operated. The acoustic energy may also be generated passively, such as when tubing flow is present in the tubing 24, downhole tools 26, and the like. These acoustic energy may mechanically deform the optical fiber 50 such that the optical propagation distance along the optical fiber 50 changes (i.e., the length of a waveguide section between Bragg gratings is perturbed by the force of acoustic pressure thereon).

The DAS system 40 may have a spatial resolution of one meter, for example, along the optical fiber 50, depending on the pulse width of the source. Therefore, the optical fiber 50 may be capable of producing the functional equivalent of tens, hundreds, or even thousands of acoustic sensors along the optical fiber 50. The bandwidth of the signal that may be measured is typically within the acoustic range (i.e., 20 Hz to 20 kHz), but the DAS system 40 may also be capable of sensing in the sub-acoustic (i.e., less than 20 Hz) and/or ultrasound (i.e., greater than 20 kHz) ranges.

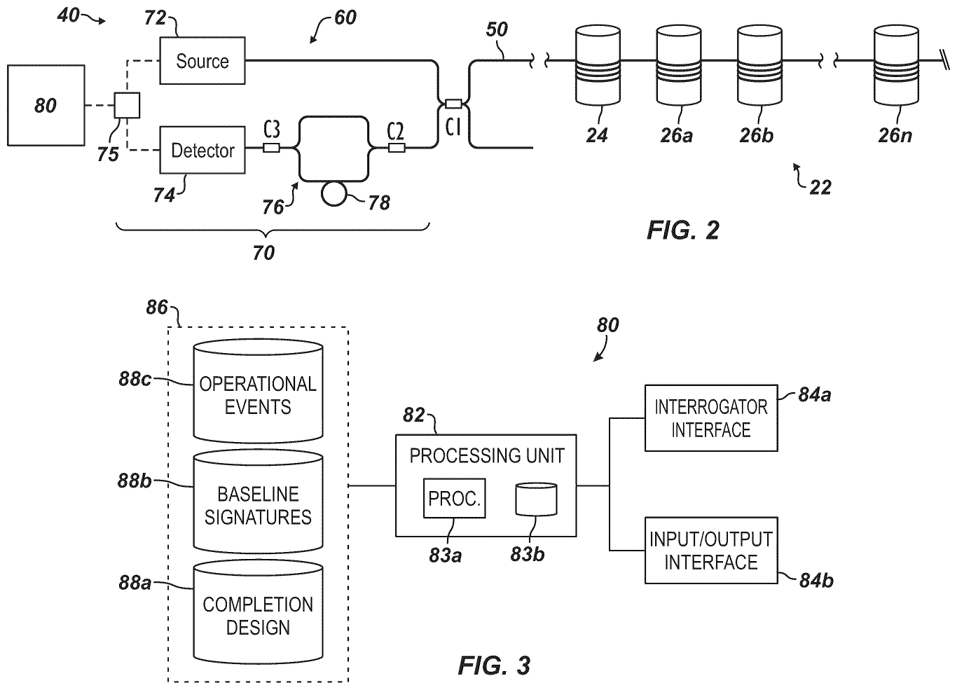

FIG. 2 illustrates a schematic view of the completion assembly 20 and the DAS system 40. As noted above, the completion assembly 20 used in a wellbore (10) includes a plurality components for use downhole on the completion assembly in the wellbore (10). These downhole components include tubing 24 (e.g., tubular, production tubing, liner, etc.), downhole tools 26a-n, and the like. Again, the downhole tools 26a-n can include a wellscreen (e.g., sand screen, gravel pack screen, etc.), a subsurface safety valve (e.g., a tubing-retrievable safety valve), a packer, a sliding sleeve, an inflow control valve, a chemical injection device, a gas lift device, an electric submersible pump (ESP), etc. depending on the implementation.

The DAS system 40 includes the optical fiber 50 and the monitoring unit 60. Although reference to the optical fiber 50 may be used herein, it will be appreciated that the optical fiber 50 may be implemented in a cable, and more than one optical fiber 50 can be used. In general and as noted previously, the optical fiber 50 is disposed along the completion assembly and disposed at least in acoustic communication with the downhole components 22 (e.g., tubing 24, downhole tools 26a-n, etc.).

The monitoring unit 60 includes an interrogator 70 and an analyzer 80. The interrogator 70 is in optical communication with the optical fiber 50, and the analyzer is in operational communication with the interrogator 70. Further details of the analyzer 80 are shown in FIG. 3.

Looking at the interrogator 70 in more detail, the interrogator 70 in the example of FIG. 2 has an optical source 72 and an optical detector 74. The optical source 72 is configured to inject input optical signals into the optical fiber 50, and the optical detector 74 is configured to detect return optical signals backscattered along the length of the optical fiber 50. The interrogator 70 can also include a local controller 78 to control the light generation and detection.

As noted, the optical fiber 50 itself becomes the sensing element. The optical fiber 50 can be acoustically couped to or to or wrapped about specific sections of the tubing 24 to monitor the completion assembly 20. The cable 52 having the optical fiber 50 can be acoustically coupled to or wrapped about the downhole components 24, being coupled to specific areas of the downhole components or coupled to adjacent sections of the tubing 24, etc.

During operation, the optical source 72, such as a laser, generates optical signals, such as light pulses, in one or more appropriate spectrums and injects the optical signals into the optical fiber 50. For example, the source 72 sends a coherent laser pulse along the optical fiber 50, and Rayleigh scattering within the optical fiber 50 causes the fiber 50 to act as a distributed interferometer.

Backscatter of the injected optical signal into the optical fiber 50 provides indications of the various conditions incident on the optical fiber 50. These conditions include acoustic perturbations (e.g., dynamic strain), temperature, static strain, and the like that can occur along the length of the optical fiber 50. In this way, the optical fiber 50 acts as a sensor element allowing for measurements to be taken along the length of the entire optical fiber 50.

The optical signal backscattered up the optical fiber 50 as a result of optical backscatter travels back to the interrogator 70, and the detector 78 detects the backscattered optical signal. The detector 78 can include one or more photodetectors or other sensors that can allow one or more light beams and/or backscattered light to be detected for further processing. The detector 78 can have associated optics and signal processing electronics (not shown), and the detector 78 can include a semiconductor electronic device (e.g., one or more photodiodes) that uses the photoelectric effect to convert light to electricity. Filtering and processing of the detected backscattered signal (e.g., time of flight measurements of the backscattered signal) produce optical measurements relative to a given depth or range along the optical fiber 50 at a given point in time.

The DAS system 40 can generate interferometric signals for analysis by the analyzer 80 without need for a physical interferometer. For instance, backscattered light can be directed to the detector without passing it through any interferometer. Alternatively, the backscattered light from the interrogation pulse may be mixed with the light from the source 72 originally providing the interrogation pulse. Thus, the light from the source 72, the interrogation pulse, and the backscattered signal may all be collected by detector 78 and then analyzed by the analyzer 80. Mixing the backscattered light with a local oscillator allows measuring the phase of the backscattered light along the optical fiber 50 relative to a reference light source.

As shown in FIG. 2, the DAS system 40 can use a single-pulse coherent Rayleigh scattering system and may include a compensating interferometer 74. The interferometer 74 has a top interferometer arm, a bottom interferometer arm, and a gauge 76 positioned on the bottom interferometer arm. The interferometer 74 is coupled to a first coupler C1 through a second coupler C2 and an optical fiber. Interferometer 14 is coupled to the detector 78 through a third coupler C3 opposite second coupler C2.

The returned backscattered light is split at second coupler C2 based on the number of interferometer arms so that one portion of any backscattered light passing through interferometer 74 travels through top interferometer arm and another portion travels through bottom interferometer arm. Therefore, the interferometer 74 can split the backscattered light from the optical fiber 50 into a first backscattered pulse and a second backscattered pulse sent respectively into top and bottom interferometer arms of the interferometer 74. These two portions are re-combined to form an interferometric signal for the detector 78.

When used, the interferometer 74 can facilitate the generation of the interferometric signal through the relative phase shift variations between the light pulses in the arms of the interferometer 74. Specifically, gauge 76 may cause the length of bottom interferometer arm to be longer than the length of top interferometer arm such that a phase shift of backscattered light between the two different points along fiber optic cable 50 may be identified in the interferometric signal.

As noted above, the interferometer 74 may not be necessary to interfere the backscattered light from pulses prior to being sent to the detector 78. In another arrangement, a compensating interferometer 74 may be placed in the launch path (i.e., prior to traveling down fiber optic cable 50) of the interrogating pulse to generate a pair of pulses that travel down fiber optic cable 50.

As the optical detector 78 collects the backscattered optical signal, the analyzer 80 processes the signals. In general, the time that the backscattered signals take to return to the detector 78 is proportional to the distance traveled along the optical fiber 50 so time of flight measurements can be used to establish distances of detection along the optical fiber 50.

For instance, the intensity of reflected light can be measured over time after transmitting the laser pulse using a technique known as Coherent Rayleigh Optical Time Domain Reflectometry (COTDR). Changes in the reflected intensity from different sections of the optical fiber 50 correspond to variations in strain and temperature. The acoustic frequency strain signals can be detected over large distances.

By using the time of flight for the optical pulses, the location of the strain along fiber optic cable 50 and the time at which it occurred may be determined. If fiber optic cable 50 is positioned within a wellbore, the locations of the strains in fiber optic cable 50 may be correlated with depths of the completion assembly 20 in the formation in order to associate the return signals (and resulting process signals) with locations of the downhole components 22 on the completion assembly 20.

The strain resolution to measure strain depends on the carrier-to-noise ratio of the returning optical signal. Meanwhile, the spatial resolution is determined by the duration (e.g., 100 ns for 10 m resolution) of the transmitted pulse. Typical values may range from a resolution of 1 m to 10 m. Overall, longer pulses increase reflected light but reduce resolution. Depending on the resolution needed, larger averages or ranges can be used for computing purposes. The DAS system 40 can be sensitive to various noise sources (e.g., temperature fluctuations, vibrations, etc.). Therefore, signal processing techniques are used to enhance signal-to-noise ratio.

The analyzer 80 analyzes the detected backscattered signals to characterize the downhole components 22 adjacent to the optical fiber 50. The spectral width, frequency, and other parameters of the optical source are controlled so the detected backscattered signal can be appropriately analyzed for any characteristics and/or disturbances along the optical fiber 50. The various characteristics and/or disturbances along the optical fiber 50 can produce changes in the properties of the backscattered light.

The DAS system 40 enables continuous, real-time measurements along the entire length of the optical fiber 50, and the DAS system 40 can detect acoustic sources located near the optical fiber 50. This is possible because the optical fiber 50 acts as a distributed sensor. In general, the analyzer 80 can detect a variety of parameters and/or disturbances of the completion components, including detecting temperatures, acoustic signals, static strain, pressure, mechanical disturbances (micro-bending or strain), or any combination thereof. In general, any acoustic or dynamic strain disturbances along the length of the optical fiber 50 can result in a change in the properties of the backscattered light, allowing for a distributed measurement of both the acoustic magnitude (e.g., amplitude), frequency and, in some cases, of the relative phase of the disturbance. Any suitable detection methods including the use of highly coherent light beams, compensating interferometers, local oscillators, and the like can be used to produce one or more signals that can be processed to determine the acoustic signals or strain impacting the optical fiber along its length.

When acoustic energy (such as generated by fluid flow, fractures, or equipment) interacts with the optical fiber 50, for example, the acoustic energy causes micro-bending or strain in the optical fiber 50. The coherent laser pulse is transmitted along the optical fiber 50, which acts as a distributed interferometer, and returning light is detected at the detector 78 as interferometric measurement. The analyzer 80 analyzes the detected measurements to detect variations in strain and acoustic signals. The spatial resolution depends on the pulse duration and the speed of light in the optical fiber 50. Shorter pulses provide higher resolution. The DAS system 40 can continuously sample the optical fiber 50, providing real-time and historical data.

To detect temperatures, the analyzer 80 can compare the optical signals injected into the optical fiber 50 with the reflected signals to determine a temperature and/or strain based on optical time-domain reflectometry. A pulsed laser from the light source coupled to the optical fiber 50 injects pulsed light. The injected light is backscattered as the pulse propagates through the optical fiber 50 due to the density and composition of the optical fiber 50 as well as molecular and bulk vibrations. A portion of the backscattered light guided back to the interrogator 70 is split off by a directional coupler to the detector. The intensity of the backscattered light decays exponentially with time. Because the speed of light within the optical fiber 50 is known, the distance that the light has passed through the optical fiber 50 can be derived using time of flight measurements.

In the DAS system 40, the backscattered signal includes different spectral components which contain peaks that are known as Rayleigh and Brillouin peaks and Raman bands. The Rayleigh peaks are independent of temperature and can be used to determine the DAS components of the backscattered signal. The Raman spectral bands are caused by thermally influenced molecular vibrations. The Raman spectral bands can be used to obtain information about distribution of temperature along the length of the optical fiber disposed in the wellbore.

The Raman backscattered light has two components, which include Stokes and Anti-Stokes components, one being only weakly dependent on temperature and the other being greatly influenced by temperature. The relative intensities between the Stokes and Anti-Stokes components are a function of temperature at which the backscattering occurred. Therefore, temperature can be determined at any point along the length of the optical fiber by comparing at each point the Stokes and Anti-stokes components of the light backscattered from the particular point. The Brillouin peaks may be used to monitor strain along the length of the optical fiber.

By analyzing acoustic signals processed by the analyzer 80, operators can optimize production rates, identify wellbore obstructions, prevent sand production, and provide other solutions. For example, the DAS system 40 can detect fluid flow rates and identify flow anomalies (such as leaks or crossflows) at different depths within the wellbore 10. The DAS system 40 can detect casing leaks, tubing movement, and other mechanical issues.

As shown in FIG. 3, the analyzer 80 includes a processing unit 82 and memory 86. As generally shown, the processing unit 82 includes one or more processors 83a and includes processing memory 83b. The processing unit 82 is implemented in hardware, firmware, or a combination of hardware and software. The processing unit 82 can be a microprocessor, a microcontroller, a digital signal processor (DSP), a field-programmable gate array (FPGA), an application-specific integrated circuit (ASIC), or another type of processing component. In some examples, the processing unit 82 can include one or more processors capable of being programmed to perform a function.

The analyzer's memory 86 has one or more databases storing information as discussed in more detail below. As generally shown here, the one or more databases include a database 88a storing information about the completion assembly and its design, a database 88b storing information about baseline signatures associated with the downhole components, and a database 88c storing information about a plurality of operational events associated with the downhole components. The memory 86 may include one or more memories, such as a random-access memory (RAM), a read only memory (ROM), and/or another type of dynamic or static storage device (e.g., a flash memory, a magnetic memory, and/or an optical memory) that stores information and/or instructions for use by the processing unit 82.

The processing unit 82 is in operational communication with the interrogator 70 using an interrogator interface 84a. The processing unit 82 can also be in operational communication with additional inputs and outputs through an input/output interface 84b.

The analyzer 80 may perform one or more processes described herein. The analyzer 80 may perform these processes by the processing unit 82 executing software instructions stored by a non-transitory computer-readable medium, such as the memory 83b. A computer-readable medium is defined herein as a non-transitory memory device. A memory device includes memory space within a single physical storage device or memory space spread across multiple physical storage devices.

Instructions may be read into the memory 83b from another computer-readable medium or from another device via the interface 84b. When executed, instructions stored in the memory 83b may instruct the processing unit 82 to perform one or more processes described herein. Additionally, or alternatively, hardwired circuitry may be used in place of or in combination with instructions to perform one or more processes described herein. Thus, implementations described herein are not limited to any specific combination of hardware circuitry and software.

The number and arrangement of components shown in FIG. 3 are provided as an example. In practice, the analyzer 80 may include additional components, fewer components, different components, or differently arranged components than those shown in FIG. 3. Additionally, or alternatively, a set of components (e.g., one or more components) of the wireless electronic controller 80 may perform one or more functions described as being performed by another set of components of the analyzer 80.

As noted above, the DAS system 40 run along the length of the completion assembly 20 monitors for changes (deviations) in the acoustic signal over time. The monitored changes can be identified as changes in frequency, amplitude, and location (e.g., depth) in the components 22 of the completion assembly 20 and in the wellbore 10. Each change can reflect a unique change in the health of the components 22 of the completion assembly 20.

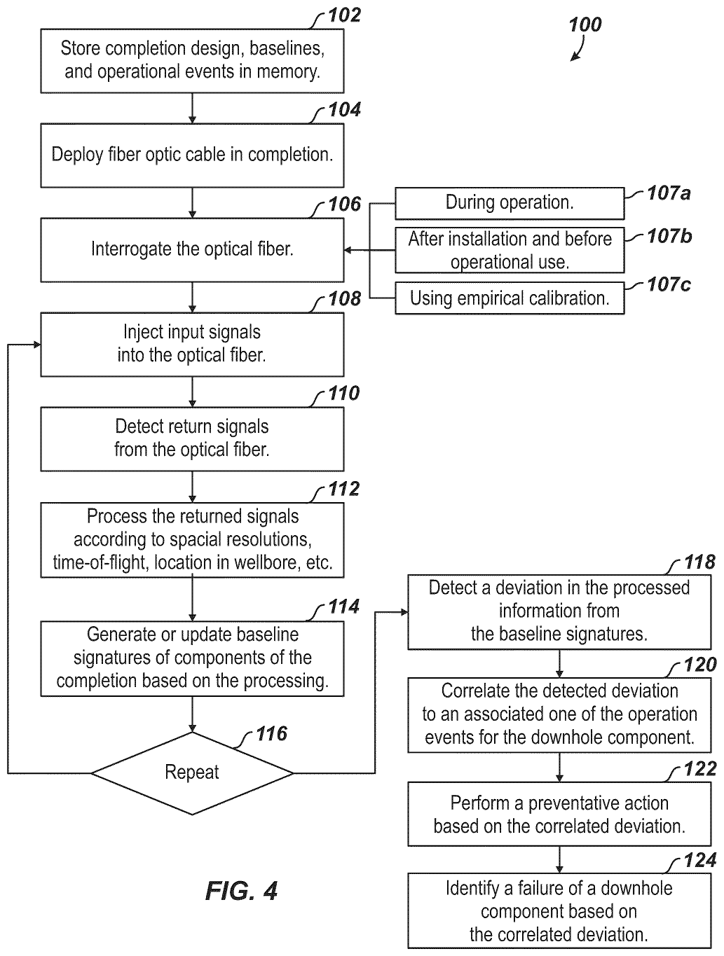

Details of the DAS system and analysis are discussed with reference to FIG. 4, which shows a process 100 for monitoring downhole components 22 of a completion assembly 20 using distributed acoustic sensing. The process 100 as noted is implemented using a computerized monitoring system 40 to monitor a completion assembly 20 disposed in a wellbore 10. As noted, the completion assembly 20 has a plurality of downhole components 22 disposed at depths in the wellbore 10. Information about the completion assembly 20 is stored in the memory 86 of the analyzer 80 (Block 102). For example, the design of the completion assembly 20, including information about the components 22 used, the location (i.e., depth) of the components 22 in the wellbore 10, information about the production tubing 24, operations performed with the completion assembly 20 in the wellbore 10, and other information. The stored completion design gives a model of the completion assembly 20 to be monitored.

Baseline signatures of the components 22 are also stored in the memory 86. These baseline signatures provided baseline or historical characteristics of the components 22 and their operations downhole. Information of the baseline signatures can be collected empirically and can be collected over time during operation of the completion assembly 20.

A plurality of operational events associated with the downhole components are stored in memory of the computerized monitoring unit. The operational events can include a leak at or near the downhole component 22, a buildup of torque at or near the downhole component 22, a buildup of pressure at or near the downhole component 22, a buildup of scale at or near the downhole component 22, a flow obstruction at or near the downhole component 22, and the like.

The fiber optic cable 52 is deployed in the completion assembly 20 so the optical fiber 50 is disposed along the completion assembly 20 (Block 104). The optical fiber 50 disposed along the completion assembly 20 is interrogated (Block 106). Lengths or sections of the optical fiber 50 are disposed at least in acoustic communication with the downhole components 22. In the interrogation, the optical source 72 injects input optical signals into the optical fiber 50 (Block 108). Downhole, the optical fiber 50 is subject to the perturbations and disturbances associated with the downhole components 22 being monitored. The optical detector 78 detects the returned optical signals (Block 110), which can include the backscattered light return along the length of the optical fiber 50. The analyzer 80 having its processing unit 82 processes the returned optical signals into processed signals (Block 112).

As noted, injecting the input optical signals into the optical fiber 50 can involve transmitting coherent laser pulses along the optical fiber 50. In turn, detecting the return optical signals backscattered along the length of the optical fiber 50 and processing the return optical signals according to the plurality of spatial resolutions for the downhole components along the length of the optical fiber can use Coherent Rayleigh Optical Time Domain Reflectometry (COTDR).

In the analysis, the analyzer 80 can process the optical signals according to a plurality of spatial resolutions for the downhole components 22 along the length of the optical fiber 50. Based on the processed return optical signals, the analyzer 80 determines current acoustic signatures for each of the downhole components 22 at the spatial resolutions along the length of the optical fiber 50. The analyzer 80 generates baselines of the signatures over a time span for each of the downhole components 22 (Block 114). During operations of the completion assembly 20, the analyzer 80 can repeat the monitoring steps of injecting (108), detecting (110), and processing optical signals (112) (Block 116). Therefore, as the process 100 continues monitoring (injecting, detecting, and processing optical signals), the analyzer 80 can build a set of baseline signatures for the downhole components as they operate in the completion assembly 20 (Block 114).

During the monitoring and analysis, the analyzer 80 can further detect a deviation from the baseline for the signatures for at least one of the downhole components 22 (Block 118). The analyzer 80 can then correlate the detected deviation to an associated one of the operational events for the at least one downhole component 22 (Block 120).

Various parameters can be used to characterize the signatures for each of the downhole components 22. The processed optical signals returned to the interrogator 70 and analyzed by the analyzer 80 can be associated to mechanical disturbances (micro-bending or strain) in the optical fiber 50 caused by acoustic waves associated with each of the downhole components 22 at the spatial resolutions along the length of the optical fiber 50.

The baselines of these mechanical signatures can be generated over a time span for each of the downhole components 22 associated with the acoustic disturbances. The analyzer 80 can determine the deviation from the baseline for the signatures by determining a change of the mechanical disturbances (micro-bending or strain) produced in the optical fiber beyond a threshold level for the associated one of the operational events for the at least one downhole component 22.

To develop the baseline signatures, the interrogation of the optical fiber 50 can be performed at least during operational use of the completion assembly 20 over the time span for production from the wellbore (Block 107a). In this case, the optical fiber 50 can initially be interrogated over an initial time span after installation of the completion assembly 20 and before operational use to generate initial ones of the baselines of the signatures (Block 107b).

Baseline signatures can also be determined empirically (Block 107c). For example, a calibration length of a calibration optical fiber can initially be interrogated over a calibration time span for one or more of the downhole components before installation downhole in the completion assembly 20.

When the deviation is correlated to an operational event, certain remedial actions can be taken. For example, a preventative action can be performed based on the correlation of the detected deviation to the associated one of the operational events for the at least one downhole component (Block 122). Various preventative actions can be taken depending on the implementation, including, but not limited to, performing a chemical injection in the completion assembly, changing an existing chemical injection in the completion assembly 20, increasing/decreasing a chemical injection rate in the completion assembly, increasing/decreasing a frequency of exercising the at least one downhole component 22, and the like.

In one example, any buildup of material (scale/wax/asphaltenes) in the bore of the tubing 22 or downhole tool 24 can produce characteristic changes in fluid behavior. In turn, the characteristic changes in the fluid behavior caused by the buildup produces changes in the general background (baseline) signatures in the optical signal of the DAS system 40 being monitored and analyzed. In particular, the amplitude of the optical signal can change as the baseline signal-to-noise is dampened. The changing optical signatures in the optical signal can be further categorized according to a material density because the density of the material will affect the frequency of the baseline signal(s).

As noted, optical signatures can be initially characterized for when the completion components 22 are manufactured (Block 107c). A baseline of the optical signatures can also be established when the completion components 22 are installed (Block 107b). When current optical signatures are monitored during operation (Block 107a), the current optical signatures can be compared to these initial and baseline optical signatures. This comparative process can enhance the ability to detect and identify changes in the completion components 22 during operations.

The DAS system 40 allows for early detection of the above-mentioned changes to the completion functioning. This early detection allows the operators to implement preventative operations, such as increasing chemical injection rates, increasing the frequency of exercising the completion components 22, such as a tubing-retrievable safety valve (TRSV), inflow control valve (ICV), or another downhole tool 24. Detection of potential risks to the well's efficiency may also help to change the completion strategy for future wells drilled in the same field. Potential to further limit the area of investigation and focus areas for treatment as opposed to batch treatments.

When the deviation is correlated to an operational event, the analyzer 80 may at time identify a failure of the at least one downhole component 22 (Block 124). The identification is based on the correlation of the detected deviation to the associated operational events for the particular downhole component 22 and depends on the circumstance. For example, completion system 20 failures can be identified in the downhole components 22, such as packers, tubing-retrievable safety valve, chemical injection device, gas lift device, electric submersible pump, etc. Each of these downhole components 22 has the optical fiber 50 associated relative to the component 22—e.g., run across it, disposed on it, passing through a portion of it, wrapped around it, etc. As the DAS system 40 continuously monitors the downhole components 22, the analyzer 80 can build an inventory of “events” that can be identified and categorized as to what has occurred. From there, the analyzer 80 can review the preceding measurements using signal processing and machine learning techniques to identify any precursor signatures leading up to a failure “event” (seals that begin to leak, torque building, pressure building, etc.).

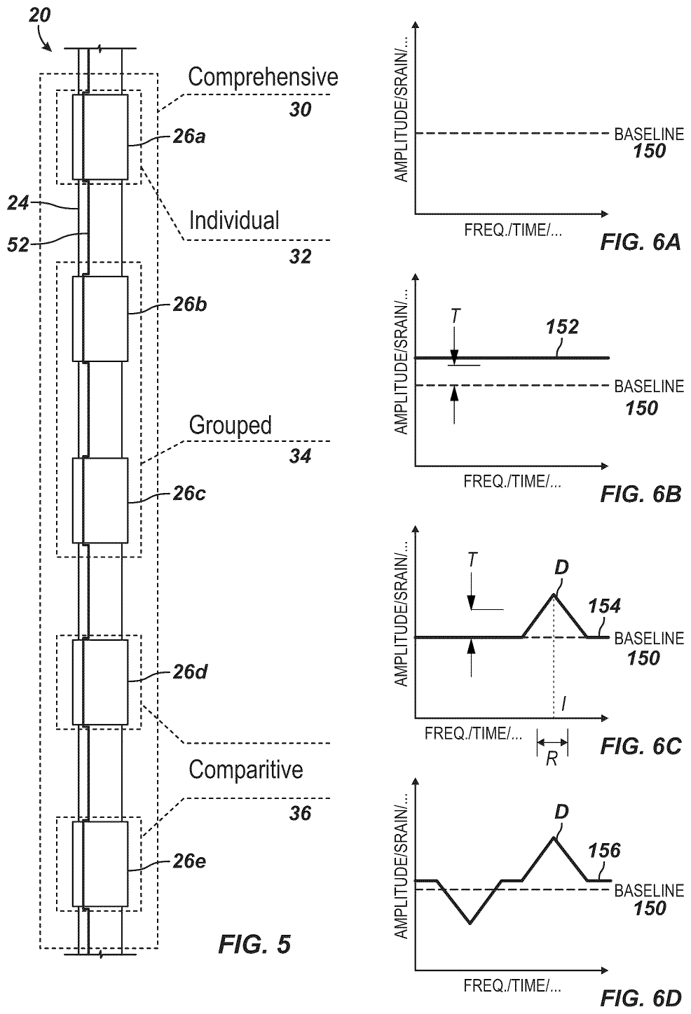

FIG. 5 illustrates another schematic view of the completion assembly 20 and the optical fiber 52 of the DAS system. As noted, the completion assembly 20 includes downhole components 26a-d disposed on a tubing or casing string 24. The optical fiber 52 is disposed along the completion assembly 20 and is disposed adjacent each of the downhole components 26a-d. Routing of the optical fiber 52 may be different than as shown—e.g., with the optical fiber 52 wrapped around portions of the components 26a-e and/or string 24.

Determining signatures, generating baselines, and detecting deviations according to the processing techniques disclosed herein can analyze various arrangements, groupings, or combinations of the completion assembly 20. For example, the processing techniques disclosed herein can determine a signature, generate a baseline, and detect a deviation of a comprehensive treatment 30 of the entire completion assembly 20 (i.e., including the string 24 and components 26a-e). The detected deviation can be correlated to operational events that involve the completion assembly 20 overall.

In another example, the processing techniques disclosed herein can determine a signature, generate a baseline, and detect a deviation of an individual treatment 32 of a portion (e.g., one component 26a) of the completion assembly 20. The detected deviation can be correlated to operational events that involve the one component 26a individually.

In yet another example, the processing techniques disclosed herein can determine a signature, generate a baseline, and detect a deviation of a grouped treatment 34 of a section (e.g., components 26b-c separated by string 24) of the completion assembly 20. The detected deviation can be correlated to operational events that involve the grouping.

In a further example, the processing techniques disclosed herein can determine a signature, generate a baseline, and detect a deviation of a comparative treatment 36 of portions (e.g., component 26d and 26e) of the completion assembly 20. The detected deviation can be correlated to operational events that involve a comparison of these components 26d, 26e.

Because a completion assembly (20) may include a disparate set of components, including tubing, downhole tools, restrictions, couplings, interfaces, seals, housings, valves, pistons, sleeves, mechanisms, etc., the processing techniques disclosed herein are configured with a disparate set of baselines, signatures, and deviations. For the sake of illustration, a few schematic examples are discussed below.

FIG. 6A illustrates a schematic graph showing an example baseline 150 determined by processing according to the present disclosure. The baseline 150 is schematically show as being linear in nature for simplification and ease of explanation. In reality, the analyzed signature generated during processing may be comprised of multiple readings and may have a more complex form. Generally, measurements may increase in value, may have more noise, and/or may have greater variations with an increase in depth in the wellbore. In any event, the measurements may be smoothed, flattened, and otherwise normalized using standard processing techniques to facilitate analysis.

In general, the values of the baseline 150 can be related to measurements of interest that are pertinent to subject portion of the completion assembly (20) of interest. These measurements of interest include the processed signals of the DAS system (40) associated with disturbances in the optical fiber (52) caused by acoustic waves associated with (e.g., produced by, experienced by, imparted from, etc.) the downhole components (22). These disturbances can be mechanical and/or acoustic in nature as discussed. The baseline 150 may be related to measurements/disturbances at a given point in time or occurring within a timeframe and may be related to the amplitude for a range of frequencies (e.g., frequency response of mechanical vibrations), levels of mechanical strain over time, etc.

FIG. 6B illustrates a schematic graph showing an example of a signature 152 deviated with one form of deviation from the baseline 150. All or a majority of the signature 152 may be shifted above or below the baseline 150. This form of deviation can relate more appropriately to a change in resonance determined downhole, such as when there is a buildup of contaminants (scale, wax, asphaltene, etc.) in the fluid flow through the subject portion (e.g., component, tubing, etc.) of the completion assembly. Determination that the deviation for the signature 152 correlates to an operational event can be based on the value, level, extent, etc. of the change from the baseline 150. For example, the deviation for the signature 152 may be compared to a threshold T to assess the deviation for the signature 152 and how it is correlated to an operational event for the subject portion (e.g., component, tubing, etc.) of the completion assembly. For example, the deviation D resulting from the disturbance in the optical fiber (52) can be detected with respect to a threshold T, which corresponds to an associated operational event. The deviation D may be detected at, beyond, or within the threshold T as the case may be.

FIG. 6C illustrates a schematic graph showing another example of a signature 154 deviated with another form of D deviation from the baseline 150. The deviation D in signature 154 includes a crest deviating above the baseline 150 or includes a trough deviating below the baseline 150. If the graphed measurements relate to frequency response, the deviation D in the signature 154 in a higher frequency range may be indicative of a fluid leak due to a failed seal, a rupture in a sidewall housing, etc. By contrast, the deviation D in the signature 154 in a lower frequency range may be indicative of an obstruction due to fouling; a trapped plug, a stuck sliding, sleeve, an inoperable movable element (e.g., valve) of a downhole tool, etc.

As before, determination that the deviation D in the signature 154 correlates to an operational event can be based on the value, level, extent, etc. of the change from the baseline 150. Again, the deviation D may be compared to a threshold T to assess the deviation D and to define how the deviation D is correlated to an operational event for the subject portion (e.g., component, tubing, etc.) of the completion assembly. Additionally or alternatively, an instantiation/of the deviation D on the signature 154 can be assessed and can define how the deviation D is correlated to an operational event for the subject portion (e.g., component, tubing, etc.) of the completion assembly. For instance, the deviation D resulting from the disturbance in the optical fiber (52) can be detected with respect to the instantiation/, which corresponds to an associated operational event. The deviation D may be detected at or within a range R of the instantiation/as the case may be. As an example, the instantiation/may relate to a frequency in the signature 154 where the deviation D peaks, and that peak frequency may correlate to a particular operational event.

FIG. 6D illustrates a schematic graph showing yet another example of a signature 156 deviated with yet another form of deviation D from the baseline 150. In this example, the signature 154 has a more complex or hybrid form of deviation D. This deviation D may be indicative one particular operational event, such as a failure, obstruction, or the like, or it may be indicative of a combination of operational events occurring together.

The techniques of the present disclosure can be implemented in digital electronic circuitry, or in computer hardware, firmware, software, or in combinations of these. Apparatus for practicing the disclosed techniques can be implemented in a computer program product tangibly embodied in a machine-readable storage device for execution by a programmable processor; and method steps of the disclosed techniques can be performed by a programmable processor executing a program of instructions to perform functions of the disclosed techniques by operating on input data and generating output. The disclosed techniques can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks;

magneto-optical disks; and CD-ROM disks. Any of the foregoing can be supplemented by, or incorporated in, ASICs (application-specific integrated circuits).

Configurations of the present disclosure can be embodied by the following clauses, which include:
Clause 1: A method implemented using a computerized monitoring system (80) to monitor a completion assembly (20) disposed in a wellbore (10), the completion assembly (20) having a plurality of downhole components (26a-b) disposed at depths in the wellbore (10), the method comprising:
storing, in memory (86) of the computerized monitoring system (80), a plurality of operational events (88c) associated with the downhole components (26a-b);
interrogating an optical fiber (50) disposed along the completion assembly (20) and disposed at least in acoustic communication with the downhole components (26a-b) by:
   injecting, using an optical source (72) of the computerized monitoring system (80), input signals into the optical fiber (50);
   detecting, using an optical detector (74) of the computerized monitoring system (80), return signals backscattered along the optical fiber (50);
   processing, using one or more processors (82) of the computerized monitoring system (80), the return signals into processed signals according to a plurality of spatial resolutions for the downhole components (26a-b) along the optical fiber (50);
   determining, using the one or more processors (82) based on the processed signals, signatures for the downhole components (26a-b) at the spatial resolutions along the optical fiber (50); and
   generating, using the one or more processors (82), baselines (88b) of the signatures over a time span for the downhole components (26a-b);
detecting, using the one or more processors (82), a deviation from the baseline in the signature for at least one of the downhole components (26a-b); and
correlating, using the one or more processors (82), the detected deviation to an associated one of the operational events (88c) for the at least one downhole component (26a-b).
Clause 2: The method of Clause 1, comprising deploying the optical fiber (50) as part of production tubing (24), as part of casing, or as a separate line for the completion assembly (20); optionally wherein the optical fiber comprises one or more of a single-mode optical fiber, a multimode optical fiber, and an engineered optical fiber; and further optionally wherein the downhole components are selected from the group consisting of tubing, a downhole tool, a wellscreen, a subsurface safety valve, a packer, a sliding sleeve, an inflow control valve, a chemical injection device, a gas lift device, and an electric submersible pump.
Clause 3: The method of Clause 1 or Clause 2, wherein storing the operational events (88c) comprises storing the operational events (88c) selected from the group consisting of a leak, a torque buildup, a pressure buildup, a scale buildup, and a flow obstruction.
Clause 4: The method of any one of Clauses 1 to 3, wherein interrogating the optical fiber (50) to generate the baselines (88b) of the signatures over the time span for each of the downhole components (26a-b) comprises performing the interrogation at least during operational use of the completion assembly (20) over the time span for production from the wellbore (10).
Clause 5: The method of any one of Clauses 1-4, wherein the method further comprises:
initially interrogating the optical fiber (50) over an initial time span after installation of the completion assembly (20) and before the operational use to generate initial ones of the baselines (88b) of the signatures; and/or
initially interrogating a calibration optical fiber (50) over a calibration time span for one or more of the downhole components (26a-b) before installation of the completion assembly (20) to generate calibration ones of the baselines (88b) of the signatures.
Clause 6: The method of any one of Clauses 1 to 5, wherein injecting the input signals into the optical fiber (50) comprises transmitting coherent laser pulses along the optical fiber (50); and/or wherein detecting the return signals backscattered along the optical fiber (50) and processing the return signals according to the plurality of spatial resolutions for the downhole components (26a-b) along the optical fiber (50) comprise using Coherent Rayleigh Optical Time Domain Reflectometry (COTDR).
Clause 7: The method of any one of Clauses 1 to 6, wherein processing the return signals into the processed signals and determining the signatures based on the processed signals comprises associating the processed signals to disturbances in the optical fiber (50) caused by acoustic waves associated with the downhole components (26a-b) at the spatial resolutions along the optical fiber (50).
Clause 8: The method of Clause 7, wherein generating the baselines (88b) of the signatures over the time span for each of the downhole components (26a-b) comprises generating the baselines (88b) from the disturbances.
Clause 9: The method of Clauses 7 or 8, wherein detecting the deviation from the baseline in the signature for at least one of the downhole components (26a-b) comprises detecting a change of the disturbance with respect to a threshold, the threshold corresponding to the associated one of the operational events (88c) for the at least one downhole component (26a-b).
Clause 10: The method of Clause 7, 8 or 9, wherein detecting the deviation from the baseline in the signature for at least one of the downhole components (26a-b) comprises detecting the disturbance with respect to an instantiation in the signature, the instantiation corresponding to the associated one of the operational events (88c) for the at least one downhole component (26a-b).
Clause 11: The method of any one of Clauses 1 to 12, wherein the method further comprises performing a preventative action based on the correlation of the detected deviation to the associated one of the operational events (88c) for the at least one downhole component (26a-b).
Clause 12: The method of Clause 11, wherein performing the preventative action is selected from the group consisting of: performing a chemical injection in the completion assembly (20), changing an existing chemical injection in the completion assembly (20), increasing/decreasing a chemical injection rate in the completion assembly (20), and increasing/decreasing a frequency of exercising the at least one downhole component (26a-b).
Clause 13: The method of any one of Clauses 1 to 12, wherein the method further comprises identifying, using the one or more processors (82), a failure of the at least one downhole component (26a-b) based on the correlation of the detected deviation to the associated one of the operational events (88c) for the at least one downhole component (26a-b).
Clause 14: A programmable storage device (83b) having program instructions stored thereon for causing one or more processors (82) to perform a method of any one of Clauses 1 to 15 implemented using a computerized monitoring system (80) to monitor a completion assembly (20) disposed in a wellbore (10).
Clause 15: A system used for a completion assembly (20) disposed in a wellbore (10), the completion assembly (20) having a plurality of downhole components (26a-b) disposed at depths in the wellbore (10), the system comprising:
a memory (86) storing a plurality of operational events (88c) associated with the downhole components (26a-b);
an optical fiber (50) disposed along the completion assembly (20) and disposed at least in acoustic communication with one or more of the downhole components (26a-b);
an interrogator (60) in optical communication with the optical fiber (50), the interrogator (60) having an optical generator and an optical detector (74), the optical generator configured to inject input signals into the optical fiber (50), the optical detector (74) being configured to detect return signals backscattered along the optical fiber (50); and
one or more processors (82) in operational communication with the interrogator (60), the one or more processors (82) being configured to:
   process the return signals into processed signals according to a plurality of spatial resolutions for the downhole components (26a-b) along the optical fiber (50);
   determine, from the processed signals, signatures for the downhole components (26a-b) at the spatial resolutions along the optical fiber (50);
   generate baselines (88b) of the signatures over a time span for the downhole components (26a-b);
   detect a deviation from the baseline in the signature for at least one of the downhole components (26a-b); and
   correlate the detected deviation to an associated one of the operational events (88c) for the at least one downhole component (26a-b).
Clause 16: A completion assembly (20) for use in a wellbore (10), the completion assembly (20) comprising:
a plurality components for use downhole on the completion assembly (20) in the wellbore (10); and
a monitoring system (80), comprising:
   a memory (86) storing a plurality of operational events (88c) associated with the downhole components (26a-b);
   an optical fiber (50) disposed along the completion assembly (20) and disposed at least in acoustic communication with the downhole components (26a-b);
   an interrogator (60) in optical communication with the optical fiber (50), the interrogator (60) having an optical generator and an optical detector (74), the optical generator configured to inject input signals into the optical fiber (50), the optical detector (74) being configured to detect return signals backscattered along the optical fiber (50); and
   one or more processors (82) in operation communication with the interrogator (60), the processors (82) being configured to:
      process the return signals into processed signals according to a plurality of spatial resolutions for the downhole components (26a-b) along the optical fiber (50);
      determine, from the processed signals, signatures for the downhole components (26a-b) at the spatial resolutions along the optical fiber (50);
      generate baselines (88b) of the signatures over a time span for the downhole components (26a-b);
      detect a deviation from the baseline in the signature for at least one of the downhole components (26a-b); and
      correlate the detected deviation to an associated one of the operational events (88c) for the at least one downhole component (26a-b).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method implemented using a computerized monitoring system to monitor a completion assembly disposed in a wellbore, the completion assembly having a plurality of downhole components disposed at depths in the wellbore, the method comprising:
storing, in memory of the computerized monitoring system, a plurality of operational events associated with the downhole components;
interrogating an optical fiber disposed along the completion assembly and disposed at least in acoustic communication with the downhole components by:
injecting, using an optical source of the computerized monitoring system, input signals into the optical fiber;
detecting, using an optical detector of the computerized monitoring system, return signals backscattered along the optical fiber;
processing, using one or more processors of the computerized monitoring system, the return signals into processed signals according to a plurality of spatial resolutions for the downhole components along the optical fiber;
determining, using the one or more processors based on the processed signals, signatures for the downhole components at the spatial resolutions along the optical fiber; and
generating, using the one or more processors, baselines of the signatures over a time span for the downhole components;
detecting, using the processing unit, a deviation from the baseline in the signature for at least one of the downhole components; and
correlating, using the processing unit, the detected deviation to an associated one of the operational events for the at least one downhole component.

2. The method of claim 1, comprising deploying the optical fiber as part of production tubing, as part of casing, or as a separate line for the completion assembly.

3. The method of claim 1, wherein the optical fiber comprises one or more of a single-mode optical fiber, a multimode optical fiber, and an engineered optical fiber.

4. The method of claim 1, wherein storing the operational events comprises storing the operational events selected from the group consisting of a leak, a torque buildup, a pressure buildup, a scale buildup, and a flow obstruction.

5. The method of claim 1, wherein interrogating the optical fiber to generate the baselines of the signatures over the time span for each of the downhole components comprises performing the interrogation at least during operational use of the completion assembly over the time span for production from the wellbore.

6. The method of claim 5, wherein the method further comprises initially interrogating the optical fiber over an initial time span after installation of the completion assembly and before the operational use to generate initial ones of the baselines of the signatures.

7. The method of claim 5, wherein the method further comprises initially interrogating a calibration optical fiber over a calibration time span for one or more of the downhole components before installation of the completion assembly to generate calibration ones of the baselines of the signatures.

8. The method of claim 1, wherein injecting the input signals into the optical fiber comprises transmitting coherent laser pulses along the optical fiber.

9. The method of claim 1, wherein detecting the return signals backscattered along the optical fiber and processing the return signals according to the plurality of spatial resolutions for the downhole components along the optical fiber comprise using Coherent Rayleigh Optical Time Domain Reflectometry (COTDR).

10. The method of claim 1, wherein processing the return signals into the processed signals and determining the signatures based on the processed signals comprises associating the processed signals to disturbances in the optical fiber caused by acoustic waves associated with the downhole components at the spatial resolutions along the optical fiber.

11. The method of claim 10, wherein generating the baselines of the signatures over the time span for each of the downhole components comprises generating the baselines from the disturbances.

12. The method of claim 10, wherein detecting the deviation from the baseline in the signature for at least one of the downhole components comprises detecting a change of the disturbance with respect to a threshold, the threshold corresponding to the associated one of the operational events for the at least one downhole component.

13. The method of claim 10, wherein detecting the deviation from the baseline in the signature for at least one of the downhole components comprises detecting the disturbance with respect to an instantiation in the signature, the instantiation corresponding to the associated one of the operational events for the at least one downhole component.

14. The method of claim 1, wherein the method further comprises performing a preventative action based on the correlation of the detected deviation to the associated one of the operational events for the at least one downhole component.

15. The method of claim 14, wherein performing the preventative action is selected from the group consisting of: performing a chemical injection in the completion assembly, changing an existing chemical injection in the completion assembly, increasing/decreasing a chemical injection rate in the completion assembly, and increasing/decreasing a frequency of exercising the at least one downhole component.

16. The method of claim 1, wherein the method further comprises identifying, using the processing unit, a failure of the at least one downhole component based on the correlation of the detected deviation to the associated one of the operational events for the at least one downhole component.

17. A programmable storage device having program instructions stored thereon for causing one or more processors to perform a method of claim 1 to monitor a completion assembly disposed in a wellbore.

18. A system used for a completion assembly disposed in a wellbore, the completion assembly having a plurality of downhole components disposed at depths in the wellbore, the system comprising:
a memory storing a plurality of operational events associated with the downhole components;
an optical fiber disposed along the completion assembly and disposed at least in acoustic communication with one or more of the downhole components;
an interrogator in optical communication with the optical fiber, the interrogator having an optical generator and an optical detector, the optical generator configured to inject input signals into the optical fiber, the optical detector being configured to detect return signals backscattered along the optical fiber; and
one or more processors in operational communication with the interrogator, the one or more processors being configured to:
process the return signals into processed signals according to a plurality of spatial resolutions for the downhole components along the optical fiber;
determine, from the processed signals, signatures for the downhole components at the spatial resolutions along the optical fiber;
generate baselines of the signatures over a time span for the downhole components;
detect a deviation from the baseline in the signature for at least one of the downhole components; and
correlate the detected deviation to an associated one of the operational events for the at least one downhole component.

19. A completion assembly for use in a wellbore, the completion assembly comprising:
a plurality of components for use downhole on the completion assembly in the wellbore; and
a monitoring system, comprising:
a memory storing a plurality of operational events associated with the downhole components;
an optical fiber disposed along the completion assembly and disposed at least in acoustic communication with the downhole components;
an interrogator in optical communication with the optical fiber, the interrogator having an optical generator and an optical detector, the optical generator configured to inject input signals into the optical fiber, the optical detector being configured to detect return signals backscattered along the optical fiber; and
one or more processors in operation communication with the interrogator, the one or more processors being configured to:
process the return signals into processed signals according to a plurality of spatial resolutions for the downhole components along the optical fiber;
determine, from the processed signals, signatures for the downhole components at the spatial resolutions along the optical fiber;
generate baselines of the signatures over a time span for the downhole components;
detect a deviation from the baseline in the signature for at least one of the downhole components; and
correlate the detected deviation to an associated one of the operational events for the at least one downhole component.

20. The completion assembly of claim 19, wherein the components are selected from the group consisting of tubing, a downhole tool, a wellscreen, a subsurface safety valve, a packer, a sliding sleeve, an inflow control valve, a chemical injection device, a gas lift device, and an electric submersible pump.
